(19) United States
(12) Patent Application Publication
(10) Pub. No.: US 2015/0260966 A1
(43) Pub. Date: Sep. 17, 2015

(54) PROJECTION LENS ASSEMBLY AND PROJECTION APPARATUS

(71) Applicants: Qisda Optronics (Suzhou) Co., Ltd., Suzhou (CN); Qisda Corporation, Taoyuan (TW)

(72) Inventor: MING-KUEN LIN, Taoyuan City (TW)

(21) Appl. No.: 14/656,682

(22) Filed: Mar. 12, 2015

(30) Foreign Application Priority Data
Mar. 14, 2014 (TW) 103109737

(51) Int. Cl. G02B 13/16; G02B 27/00; G02B 9/60

(52) U.S. Cl. CPC G02B 13/16; G02B 9/60; G02B 27/0025

(57) ABSTRACT

A projection lens assembly is provided. The projection lens assembly includes a first lens group and a second lens group. The first lens group has a negative dioptre and is disposed adjacent to an object side. The first lens group includes a first lens having a negative dioptre. The second lens group has a positive dioptre and is disposed adjacent to an image side. The second lens group includes a second lens having a positive dioptre and a third lens having a negative dioptre. The second lens is disposed between the first lens and the third lens. The third lens is made of heavy flint glass. A temperature coefficient of refractive index of the second lens is represented by D₀, and −3.0×e⁻⁵≦D₀≦−6.0×e⁻⁷. A projection apparatus is also provided.

### FIELD OF THE INVENTION

The present invention relates to a projection lens assembly and a related projection apparatus, and more particularly to a projection lens assembly and a related projection apparatus capable of spontaneously compensating the focus shift/defocus caused by thermal shift.

### BACKGROUND OF THE INVENTION

In order to save costs, the conventional projection apparatus usually use aspherical lenses as the projection lens. Basically, the aspherical lenses are made of plastic; thus, a poor production yield may occur if the projection apparatus has a relatively large number of aspherical lenses. In addition, with the increased brightness of projection apparatus, the plastic aspherical lenses may have some defects caused by heat, such as thermal shift and coating separation. Particularly, the heat the optical engine suffering increases with the operation time of the projection apparatus, which changes the refractive index of the optical elements in the optical engine and makes the metal casing of the optical engine expanded, and results in focus shift/defocus of the projection lens; thus, the thermal shift happens and the imaging quality is negatively affected. Therefore, it is quite important to design a projection lens assembly capable of compensating the thermal shift and avoiding the focus shift/defocus.

### SUMMARY OF THE INVENTION

Therefore, one object of the present invention is to provide a projection lens assembly and a projection apparatus capable of spontaneously compensating the focus shift/defocus caused by thermal shift.

The present invention provides a projection lens assembly, which includes a first lens group and a second lens group. The first lens group has a negative dioptre and is disposed adjacent to an object side. The first lens group includes a first lens having a negative dioptre. The second lens group has a positive dioptre and is disposed adjacent to an image side. The second lens group includes a second lens having a positive dioptre and a third lens having a negative dioptre. The second lens is disposed between the first lens and the third lens. The third lens is made of heavy flint glass. A temperature coefficient of refractive index of the second lens represents D₀, and −3.0×e⁻⁵≦D₀≦−6.0×e⁻⁷.

The present invention further provides projection apparatus for projecting an image onto a screen. The projection apparatus includes a light source, an imaging unit and a projection lens assembly. The light source is for providing a light. The imaging unit is for receiving the light. The projection lens assembly is disposed between the imaging unit and the screen and for projecting the light onto the screen. The projection lens assembly includes a first lens group and a second lens group. The first lens group has a negative dioptre and is disposed adjacent to the screen. The first lens group includes a first lens having a negative dioptre. The second lens group has a positive dioptre and is disposed adjacent to the image side. The second lens group includes a second lens having a positive dioptre and a third lens having a negative dioptre. The second lens is disposed between the first lens and the third lens. The third lens is made of heavy flint glass. A temperature coefficient of refractive index of the second lens represents D₀, and −3.0×e⁻⁵≦D₀≦−6.0×e⁻⁷.

Summarily, in the present invention, all of the lenses in the first and second lens groups are spherical lenses, preferably. The third lens is made of heavy flint glass to eliminate the chromatic aberration of the projection lens assembly. The second lens is used to compensate the thermal shift of the third lens and the expansion of the optical engine, wherein temperature coefficient of refractive index (the varying ratio of the refractive index affected by temperature difference) of the second lens represents D₀, and −3.0×e⁻⁵≦D₀≦−6.0×e⁻⁷. Thus, compared with the conventional technology, the projection lens assembly and the related projection apparatus of the present invention have some specific advantages such as lower manufacturing cost and easier operation. In addition, the projection lens assembly and the related projection apparatus of the present invention can provide qualified thermal shift compensation effect in response to the high brightness projection demand.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of a projection apparatus in accordance with an embodiment of the present invention;

FIG. 2 is a schematic structural diagram of a part of the projection apparatus 10 of FIG. 1;

FIG. 3 is a simulation diagram of the resolving power of the projection apparatus of FIG. 1 before thermal shift in accordance with an embodiment of the present invention;

FIG. 4 is a simulation diagram of the resolving power of the third lens in FIG. 2 after thermal shift in accordance with an embodiment of the present invention;

FIG. 5 is a simulation diagram of the resolving power of a casing of an optical engine after thermal shift in accordance with an embodiment of the present invention;

FIG. 6 is a simulation diagram of the resolving power of the second lens in FIG. 2 after thermal shift in accordance with an embodiment of the present invention;

FIG. 7 is a simulation diagram of the resolving power of the fourth lens in FIG. 2 after thermal shift in accordance with an embodiment of the present invention; and

FIG. 8 is a simulation diagram of the resolving power of the projection apparatus of FIG. 1 after the thermal shift is compensated in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

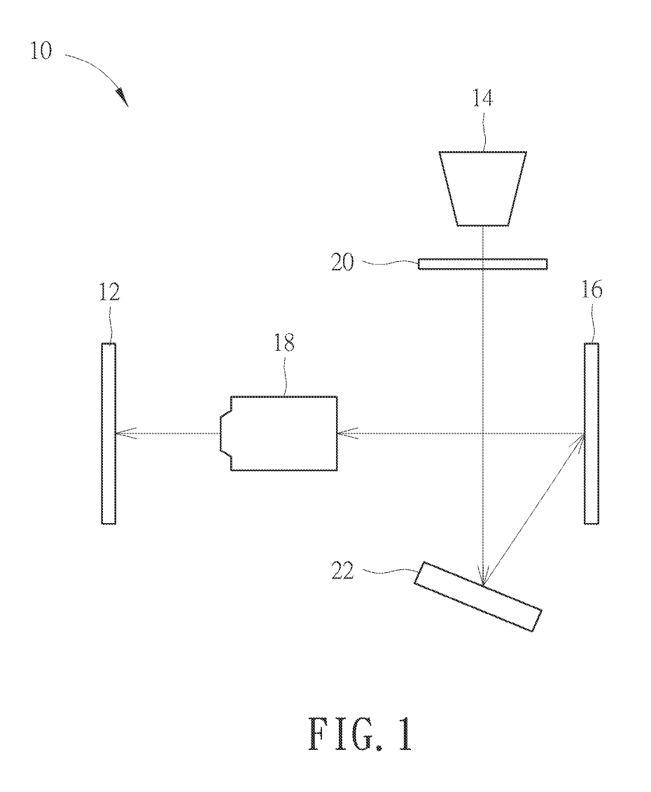

FIG. 1 is a schematic diagram of a projection apparatus in accordance with an embodiment of the present invention. As shown in FIG. 1, the projection apparatus 10 in the present embodiment is for projecting images onto a screen 12 and includes a light source 14, an imaging unit 16, a projection lens assembly 18, a light filter unit 20 and a reflective element 22. Specifically, the light source 14 is for outputting light. The light filter unit 20 is for receiving a light from the light source 14 and filtering the light into a plurality of color lights. The reflective element 22 is for reflecting the plurality of color lights from the light filter unit 20 to the imaging unit 16. The imaging unit 16 is for receiving the plurality of color lights reflected by the reflective element 22 and transmitting the plurality of color lights to the projection lens assembly 18. The projection lens assembly 18, disposed between the imaging unit 16 and the screen 12, is for projecting the color lights from the imaging unit 16 onto the screen 12. In one embodiment, the projection apparatus 10 is a digital light processing (DLP) projection apparatus, the light filter unit 20 is a color wheel, the imaging unit 16 is a digital micromirror device (DMD) and the reflective element 22 is a concave mirror. In another embodiment, the projection apparatus 10 is a liquid crystal projection apparatus, the light filter unit 20 is a filter film, the reflective element 22 is a mirror and the imaging unit 16 is a liquid crystal display (LCD) panel.

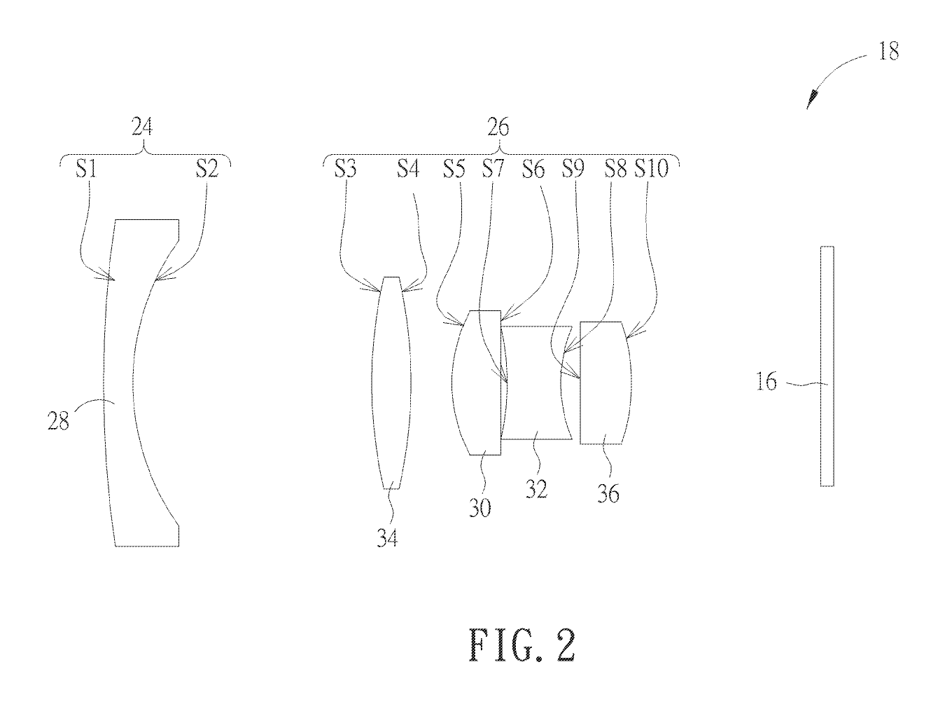

Please refer to FIG. 2, which is a schematic structural diagram of a part of the projection apparatus 10 of FIG. 1. As shown in FIG. 2, the projection lens assembly 18 includes a first lens group 24 and a second lens group 26. The first lens group 24 is disposed adjacent to the screen 12 (i.e., an object side, shown in FIG. 1) and the second lens group 26 is disposed adjacent to the imaging unit 16 (i.e., an image side). The first lens group 24 has a negative dioptre and is used to diverge light. The second lens group 26 has a positive dioptre and is used to converge light. The first lens group 24 includes a first lens 28 having a negative dioptre. The second lens group 26 includes a second lens 30 having a positive dioptre and a third lens 32 having a negative dioptre. Because there is no spacer ring disposed between the second lens 30 and the third lens 32, the second lens 30 may be abutted against the third lens 32.

In one preferred embodiment, the third lens 32 is a biconcave (concave-concave) lens, and made of heavy flint glass. Because of having the properties of higher refractive index and higher dispersion coefficient, the heavy flint glass herein is mainly used for eliminating the chromatic aberration of the projection lens assembly 18. In response to the material properties of the heavy flint glass, preferably, the refractive index of the third lens 32 is between 1.64 and 1.87 and the Abbe number of the third lens 32 is between 20 and 35. In the present invention, the third lens 32 usually has a specific lens model such as S-TIH or S-TIM; however, the present invention is not limited thereto.

When the focusing of the projection apparatus 10 is completed, the third lens 32 may have a relatively large thermal shift due to having the metal casing of the projection apparatus 10 being expanded by heat increasing with the operation time; thus, the best focus may move to be in front (or, left) of the imaging unit 16 (equivalently, the back focal length is becoming longer) and the projection lens assembly 18 may have or experience focus shift/defocus. To compensate the aforementioned thermal shift, the second lens 30 is disposed between the first lens 28 and the third lens 32 in the present invention. Specifically, the temperature coefficient of refractive index of the second lens 30 is represented by D₀ and the refractive index of the second lens 30 is represented by n, wherein −3.0×e⁻⁵≦D₀≦−6.0×e⁻⁷ and n≧1.57. The temperature coefficient of refractive index herein is defined as the ratio of the variation of the refractive index to the temperature difference

$$\frac{Δ n}{Δ T}$$

(and is equivalent to

$$\frac{d n}{d T} ) .$$

Specifically, the focus point has a smaller position change when the temperature coefficient of refractive index is higher than an upper limit. On the contrary, a smaller temperature coefficient of refractive index can result in a better compensation effect. In the present invention, the temperature coefficient of refractive index of the second lens 30 is represented by D₀ and D₀ is not smaller than −3.0×e⁻⁵ due to the limitation of the material properties of lenses. Table 1 lists several lens models applicable to the second lens 30 of the present invention.

TABLE 1

| | | Temperature |
|---|---|---|
| | | coefficient of |
| | | refractive index |
| Lens model | Refractive index (n) | (D₀) |
| S-PHM52 | 1.618 | −1.02E−05 |
| S-PHM53 | 1.603 | −8.17E−06 |
| S-BAL3 | 1.57135 | −4.21E−06 |
| S-LAM3 | 1.717004 | −3.1827E−06 |
| S-NPH1 | 1.808095 | −3.17E−06 |
| S-BAL2 | 1.570989 | −3.14E−06 |
| S-FTM16 | 1.5927 | −2.67E−06 |
| S-LAL12 | 1.678 | −1.05E−06 |
| S-LAL54 | 1.651 | −6.57E−07 |

Preferably, the thermal shift is compensated by the second lens 30 in the present invention. However, it is understood that more than one lens may be employed if the thermal shift compensation effect provided by the one single second lens 30 is not as expected. For example, in one embodiment, the second lens group 26 may selectively include a fourth lens 34 having a positive dioptre and a fifth lens 36, which are disposed on the two opposite sides of the third lens 32, respectively. The fourth lens 34 herein is used to enhance the compensation of the thermal shift of the projection apparatus 10. It is to be noted that the aforementioned amount/number and the dioptre characteristics of the lenses in the second lens group 26 are provided for an exemplary purpose only, and the present invention is not limited thereto. The second lens group 26 may be any combination of lenses which can provide lights polymerizable function, and the following will not describe the same or similar optical characteristics of other embodiments in detail. Table 2 lists preferred parameter values of each spherical lens of the projection lens assembly 18. In Table 2, “interval” represents the distance between the surfaces in the current row and in the next adjacent row.

TABLE 2

| | | Radius | | | | Temperature |
|---|---|---|---|---|---|---|
| | | of | | | Focal | coefficient of |
| | | curvature | Interval | Lens | length | refractive |
| Lens | Surface | (mm) | (mm) | model | (mm) | index D₀ |
| 28 | 51 | 356.83 | 1.73 | S-BSL7 | −49.609652 | 2.9945E−006 |
| | S2 | 23.934 | 38.24943 | | | |
| 34 | S3 | 55.6 | 3.63 | S-LAM3 | 37.715729 | −3.1827E−006 |
| | S4 | −55.6 | 4.088774 | | | |
| 30 | S5 | 17 | 6.3 | S-PHM52 | 27.415624 | −1.0228E−005 |
| | S6 | Infinity | 0.2 | | | |
| 32 | S7 | −51.9 | 5.95 | S-TIH23 | −13.343801 | −4.3838E−007 |
| | S8 | 13.92 | 2.262091 | | | |
| 36 | S9 | −614.59 | 5.29 | S-LAL8 | 27.253024 | 4.4268E−006 |
| | S10 | −18.976 | 19.73933 | | | |

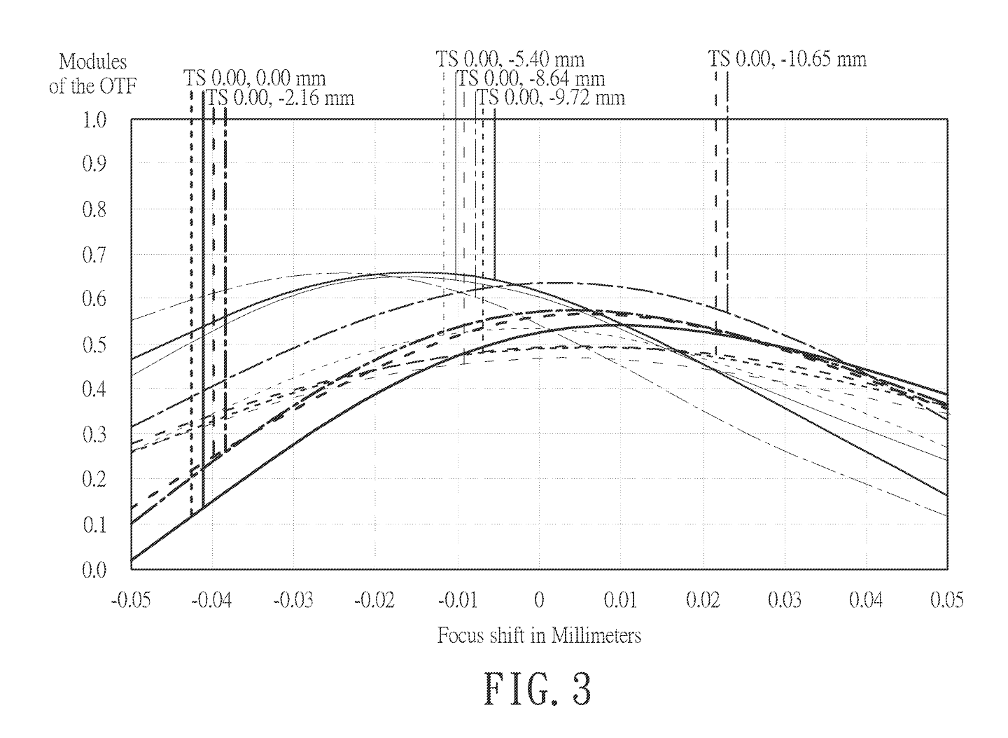

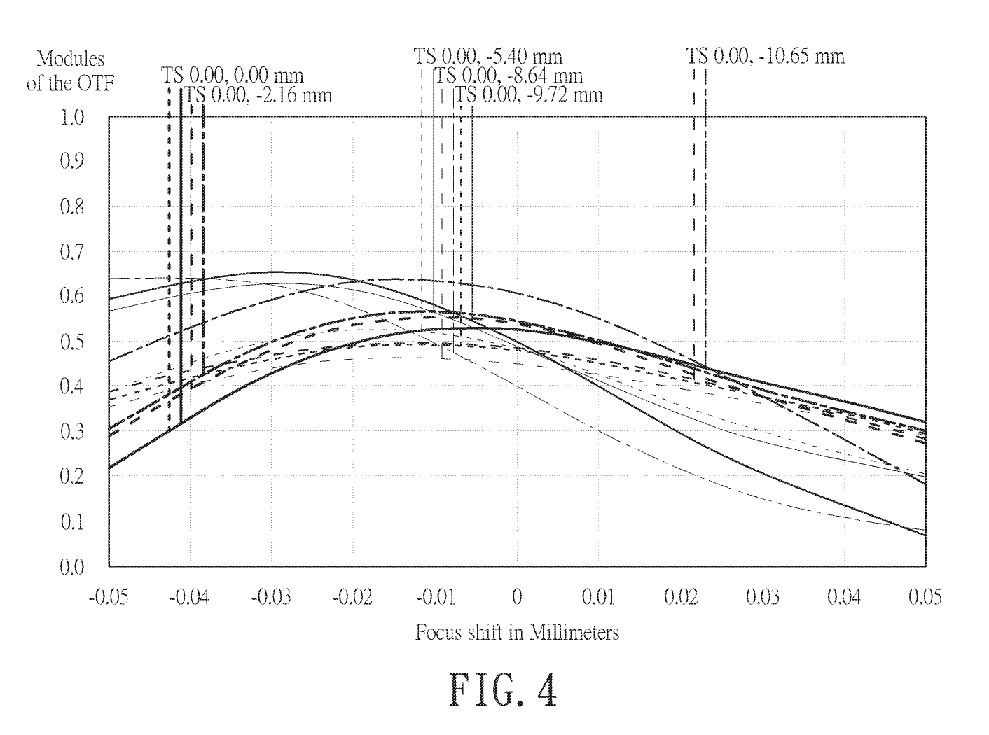

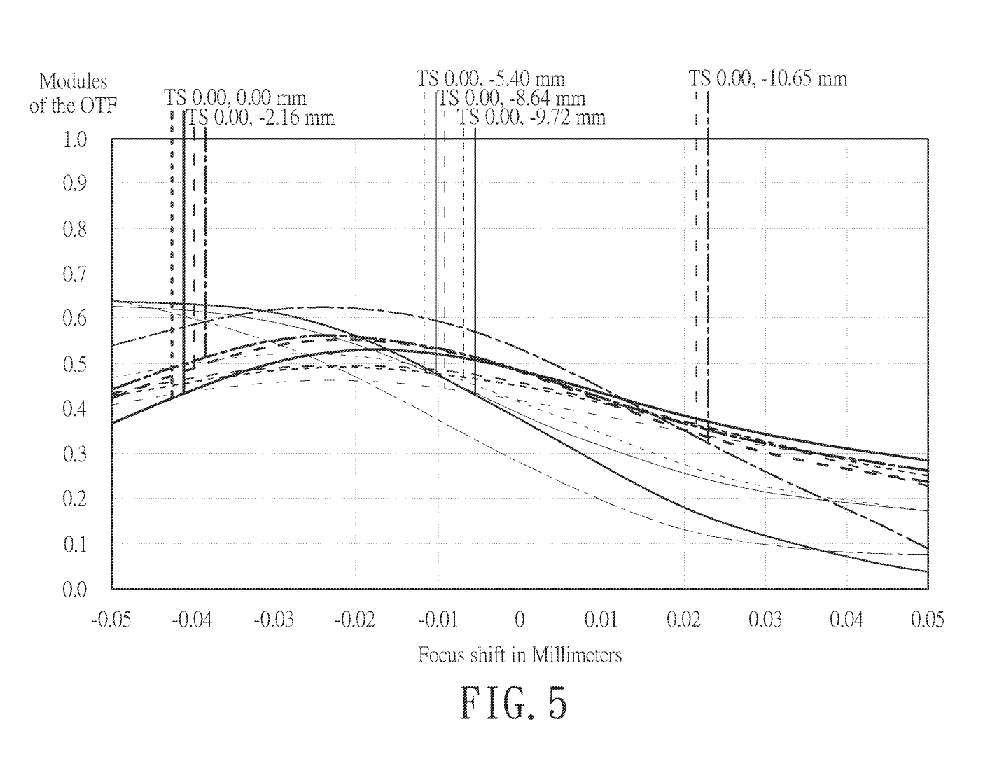

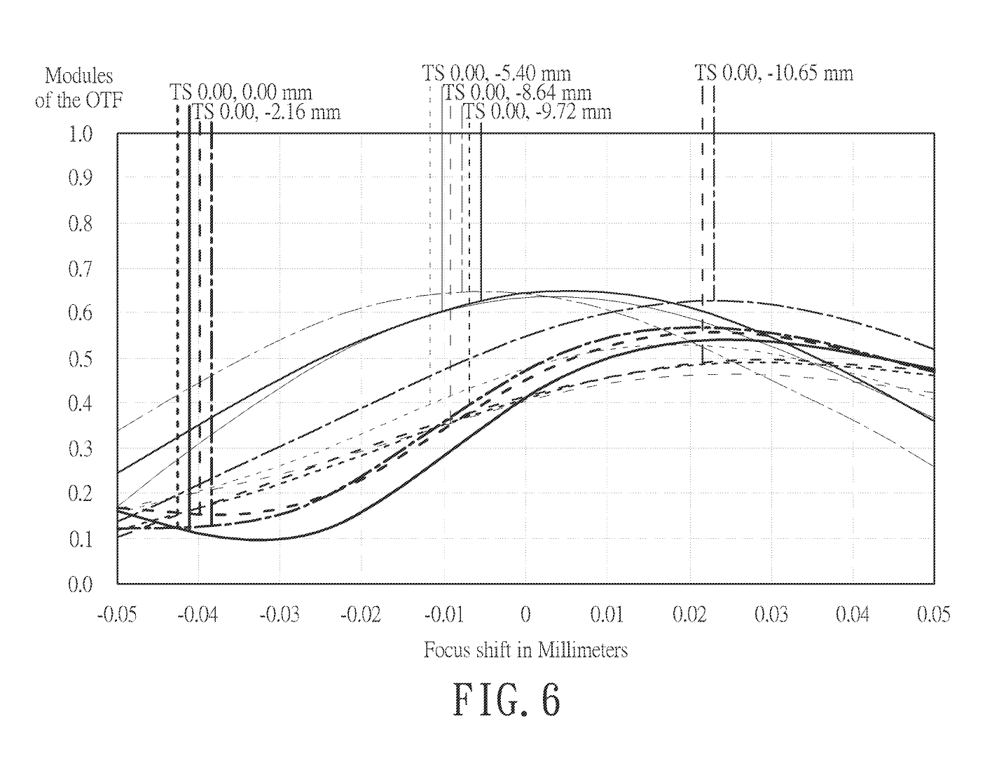

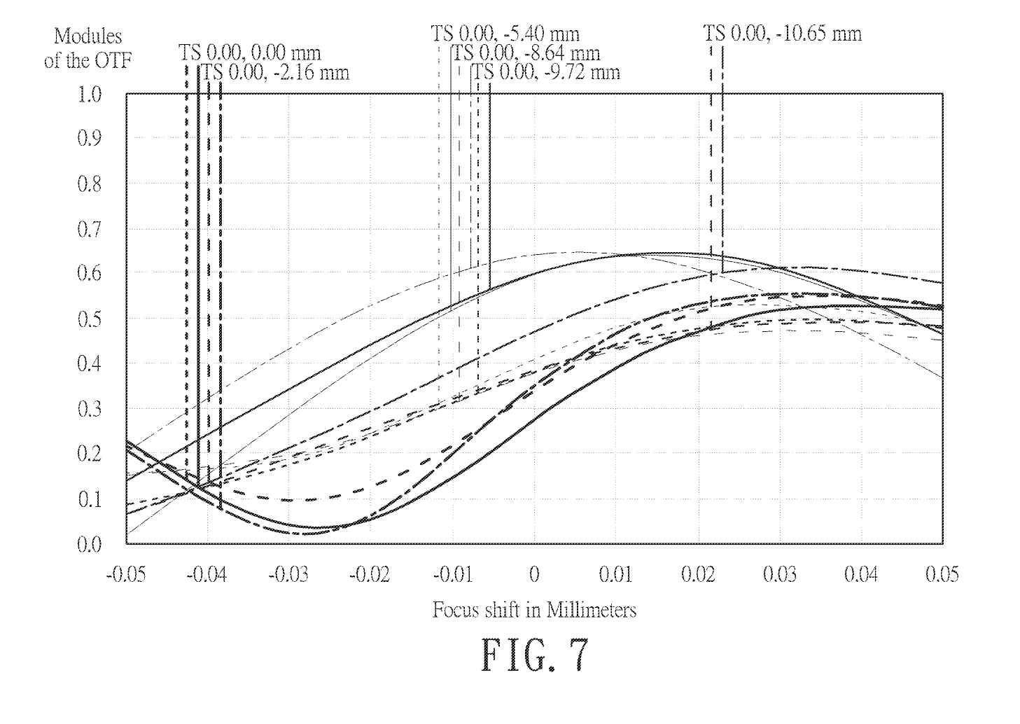

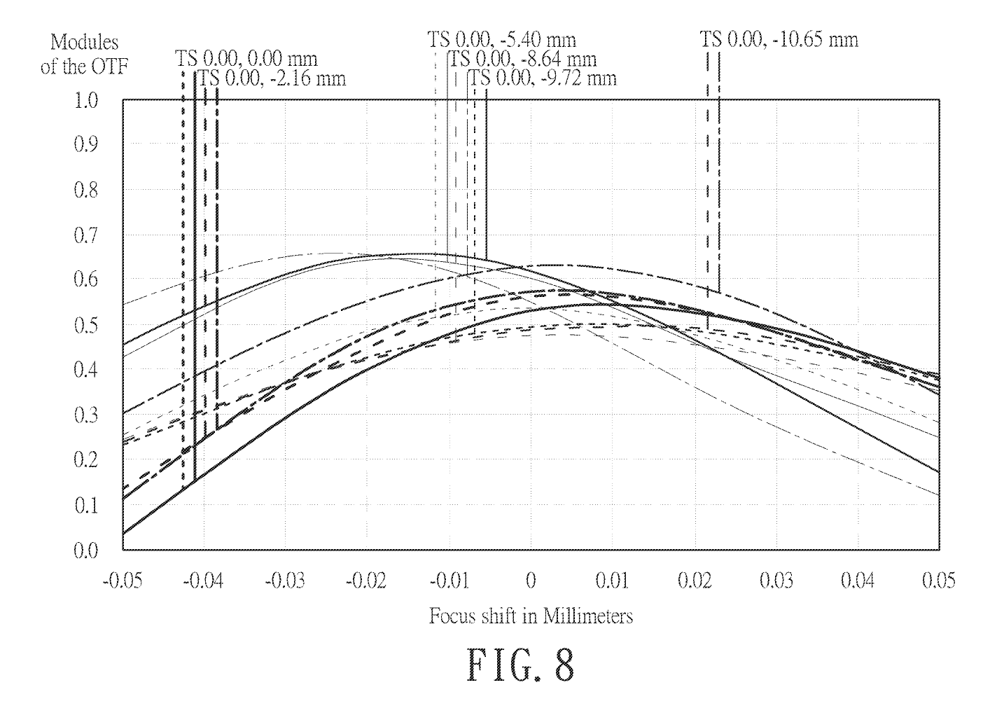

Please refer to FIGS. 3 to 8. FIG. 3 is a simulation diagram of the resolving power of the projection apparatus 10 before thermal shift in accordance with an embodiment of the present invention; FIG. 4 is a simulation diagram of the resolving power of the third lens 32 after thermal shift has occurred in accordance with an embodiment of the present invention; FIG. 5 is a simulation diagram of the resolving power of a casing of an optical engine after thermal shift has occurred in accordance with an embodiment of the present invention; FIG. 6 is a simulation diagram of the resolving power of the second lens 30 after thermal shift has occurred in accordance with an embodiment of the present invention; FIG. 7 is a simulation diagram of the resolving power of the fourth lens 34 after thermal shift has occurred in accordance with an embodiment of the present invention; and FIG. 8 is a simulation diagram of the resolving power of the projection apparatus 10 after the thermal shift is compensated in accordance with an embodiment of the present invention. In each one of the FIGS. 3 to 8, each arcuate curve corresponds to the resolving results of the specific points on the imaging unit 16 projecting onto the screen 12. The vertical axis represents the resolving power, wherein a higher value represents a better resolving power. In one embodiment, the resolving power is sufficient if at a value 0.4; the resolving power is considered good if at a value 0.5; and the resolving power is optimum if at a value 1. The horizontal axis represents the distance of Focus shift/Defocus; 0 represents the location of an image plane (the imaging unit 16); TS stands for Thermal Shift.

As shown in FIG. 3, before the thermal shift has occurred, the resolving power of the projection apparatus 10 with respect to each specific point is considered to be good (resolving power is about 0.5) and the best focus value (at the peak of the arcuate curve) is close to the origin of the horizontal axis (the imaging unit 16). Thus, the focusing of the projection apparatus 10 is completed and achieved correctly and the image can be projected onto the screen 12 clearly. However, after a long-term operation, some components in the projection apparatus 10 may have undergone thermal shift which may reduce the imaging quality of the projection lens assembly 18. For example, as shown in FIG. 4, the biconcave third lens 32 has a relatively large thermal shift due to the characteristics of heavy flint glass and the best focus (at the peak of the arcuate curve) moves left and locates in front of the imaging unit 16 with respect to the origin of the horizontal axis. Similarly, as shown in FIG. 5, the thermal expansion of the casing of the optical engine may also reduce the imaging quality and the best focus (the peak of the arcuate curve) also moves left and locates in front of the imaging unit 16 with respect to the origin of the horizontal axis.

In the projection apparatus 10 of the present invention, the thermal shift is eliminated by employing the second lens 30 having a positive dioptre and/or the fourth lenses 34. That is, the thermal shift of the projection apparatus 10 is mainly eliminated by the second lens 30 and the fourth lens 34 is selectively utilized depending on actual thermal shift elimination effect provided by the second lens 30. As shown in FIG. 6, the best focus (the peak of the arcuate curve) of the second lens 30 moves right with respect to the origin of the horizontal axis. In addition, as shown in FIG. 7, the best focus (the peak of the arcuate curve) of the fourth lens 32 also moves right with respect to the origin of the horizontal axis. Therefore, in the present invention, the thermal shift caused by the third lens 32 and the thermal expansion of the optical engine can be effectively compensated by the second lens 30 and/or the fourth lens 34; wherein the second lens 30 has a positive dioptre, a temperature coefficient of refractive index D₀ and a refraction index n, and −3.0×e⁻⁵≦D₀≦−6.0×e⁻⁷ and n≧1.57. As shown in FIG. 8, the best focus (the peak of the arcuate curve) moves close to the origin of the horizontal axis (the imaging unit 16). Therefore, the projection apparatus 10 of the present invention can have simplified operation steps and improved the projecting without a constant manual modulation or focus adjustments.

In one preferred embodiment, the projection lens assembly 18 is a non-telecentric system. Table 3 lists the preferred focal length of each optical component in the present invention. For example, the effective focal length f of the projection lens assembly 18 is 21.9 mm; the effective focal length f1 of the first lens 28 is −49.61 mm; and the effective focal length f3 of the third lens 32 is −13.343801 mm; wherein

$$1.5 \leq \vert f 1 \vert / f \leq 3.6 , and 0.3 \leq \vert f 3 \vert / f \leq 0.9 .$$

### If

$$\vert f 1 \vert / f and \vert f 3 \vert / f$$

are lower than a lower limit, then |f1| and |f3| are relatively small and the related lenses have a relatively high dioptre; as a result, the chromatic aberration issue may happen. In addition, if

$$\vert f 1 \vert / f and \vert f 3 \vert / f$$

are lower than a lower limit, then the projection lens assembly 18 needs more lenses and accordingly has a greater thermal shift which is not the issue the projection lens assembly 18 in the present invention applies for. On the contrary, if

$$\vert f 1 \vert / f and \vert f 3 \vert / f$$

are higher than an upper limit, then |f1| and |f3| are relatively large and the related lenses have a relatively low dioptre; as a result, the projection lens assembly 18 may have a relatively low magnification, which may not meet the needs or demand from user.

TABLE 3

| f (mm) | f1 (mm) | f3 (mm) |
|---|---|---|
| 21.9 | −49.609652 | −13.343801 |

Summarily, in the present invention, all of the lenses in the first and second lens groups are spherical lenses, preferably. The third lens is made of heavy flint glass to eliminate the chromatic aberration of the projection lens assembly. The second lens is used to compensate the thermal shift of the third lens and the expansion of the optical engine, wherein temperature coefficient of refractive index (the ratio of the variation of the refractive index to the temperature difference) of the second lens is represented by D₀, and −3.0×e⁻⁵≦D₀≦−6.0×e⁻⁷. Thus, compared with the conventional technology, the projection lens assembly and the related projection apparatus of the present invention have some specific advantages such as lower manufacturing cost and easier operation. In addition, the projection lens assembly and the related projection apparatus of the present invention can provide qualified thermal shift compensation effect in response to the high brightness projection demand.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A projection lens assembly, comprising:
a first lens group, having a negative dioptre and disposed adjacent to an object side, the first lens group comprising a first lens having a negative dioptre; and
a second lens group, having a positive dioptre and disposed adjacent to an image side, the second lens group comprising a second lens having a positive dioptre and a third lens having a negative dioptre,
wherein the second lens is disposed between the first lens and the third lens, and the third lens is made of heavy flint glass,
wherein a temperature coefficient of refractive index of the second lens is represented by D₀, and −3.0×e⁻⁵≦D₀≦−6.0×e⁻⁷.

2. The projection lens assembly according to claim 1, wherein a focal length of the projection lens assembly is represented by f, a focal length of the first lens is represented by f1, a focal length of the third lens is represented by f3, and
$$1.5 \leq \vert f 1 \vert / f \leq 3.6 , 0.3 \leq \vert f 3 \vert / f \leq 0.9 .$$

3. The projection lens assembly according to claim 1, wherein a refractive index of the third lens is between 1.64 and 1.87, and an Abbe number of the third lens is between 20 and 35.

4. The projection lens assembly according to claim 1, wherein the third lens is biconcave lens.

5. The projection lens assembly according to claim 1, wherein the second lens is abutted against the third lens.

6. The projection lens assembly according to claim 1, wherein a refraction ratio of the second lens is represented by n, and n≧1.57.

7. The projection lens assembly according to claim 1, wherein the second lens group further comprises a fourth lens having a positive dioptre and a fifth lens, and third lens is disposed between the fourth lens and the fifth lens.

8. A projection apparatus for projecting an image onto a screen, the projection apparatus comprising:
a light source, for providing a light;
an imaging unit, for receiving the light; and
a projection lens assembly, disposed between the imaging unit and the screen and for projecting the light onto the screen, the projection lens assembly comprising:
a first lens group, having a negative dioptre and disposed adjacent to the screen, the first lens group comprising a first lens having a negative dioptre; and
a second lens group, having a positive dioptre and disposed adjacent to the image side, the second lens group comprising a second lens having a positive dioptre and a third lens having a negative dioptre,
wherein the second lens is disposed between the first lens and the third lens, and the third lens is made of heavy flint glass,
wherein a temperature coefficient of refractive index of the second lens is represented by D₀, and −3.0×e⁻⁵≦D₀≦−6.0×e⁻⁷.

9. The projection apparatus according to claim 8, wherein a focal length of the projection lens assembly is represented by f, a focal length of the first lens is represented by f1, a focal length of the third lens is represented by f3, and
$$1.5 \leq \vert f 1 \vert / f \leq 3.6 , 0.3 \leq \vert f 3 \vert / f \leq 0.9 .$$

10. The projection apparatus according to claim 8, wherein a refractive index of the third lens is between 1.64 and 1.87, and an Abbe number of the third lens is between 20 and 35.

11. The projection apparatus according to claim 8, wherein the second lens is abutted against the third lens.

12. The projection apparatus according to claim 8, wherein a refraction ratio of the second lens is represented by n, and n≧1.57.
